(19) United States
(12) Patent Application Publication
(10) Pub. No.: US 2026/0187420 A1
(43) Pub. Date: Jul. 2, 2026

(54) SYSTEMS AND METHODS FOR PARALLEL AND SPLIT LEARNING

(71) Applicant: Huawei Technologies Co., Ltd., Shenzhen (CN)

(72) Inventors: Weisen Shi, Ottawa (CA); Xu Li, Nepean (CA); Chenchen Yang, Ottawa (CA)

(21) Appl. No.: 19/547,076

(22) Filed: Feb. 23, 2026

Related U.S. Application Data
(63) Continuation of application No. PCT/CN2023/116269, filed on Aug. 31, 2023.

(51) Int. Cl. G06N 3/047; G06N 3/045; G06N 3/084

(52) U.S. Cl. CPC G06N 3/047; G06N 3/045; G06N 3/084

(57) ABSTRACT

Provided herein are methods and systems for generating and instantiating an augmented tree model from an artificial intelligence (AI) model via a Parallel and Split Learning (PSL) controller. An example method includes dividing the original AI model into a plurality of partitions. The plurality of partitions include a bottom-level partition including an input layer of the original AI model, a top-level partition including an output layer of the original AI model, and a plurality of middle-level partitions including one or more intermediate layers between the input layer and the output layer. The divided original AI model forms an AI model. The method further includes generating the augmented tree model of the AI model and instantiating one of a plurality of nodes of the augmented tree model into one of a plurality of entities of a network.

### CROSS-REFERENCE TO RELATED APPLICATION

This application is a continuation of International Patent Application No. PCT/CN2023/116269, filed on Aug. 31, 2023, the disclosure of which is hereby incorporated by reference in its entirety.

### TECHNICAL FIELD

The disclosure generally pertains to the field of artificial intelligence (AI) and machine learning (ML), and in particular to optimizing distributed AI models using parallel and split learning techniques and augmented tree models for improved computational efficiency and reduced training latency.

### BACKGROUND

In the present day, the massive Artificial Intelligence (AI) model with millions or billions of parameters has shown great potential in various AI applications (e.g., natural language processing such as generative AI platforms and computer vision). Many have regarded it as the most promising future AI technology. However, all existing massive AI models are owned and trained by tech-giants through intensive computing resources, which are too expensive to be used by common companies or individuals. To reduce the cost of utilizing massive AI models, one promising approach is to deploy a massive AI model as a distributed system in a network environment (CN or RAN) where each network entity is embedded with a partition of the massive AI model can be afforded by the entity's computing resources.

AI models consist of two main components: encoders and classifiers. In split learning models involving multiple clients, the training process occurs sequentially, ensuring all clients contribute to the model's learning. Cluster-based parallelization, an advanced technique, enhances efficiency by categorizing devices into clusters and conducting parallel training within them.

However, current solutions have limitations, such as the lack of server-side parallelization, non-utilization of server-side partitioning for parallelization, inability to adapt to network connection variations, and pre-configured dropout rates that don't consider connection differences. Furthermore, connection outages can result in data loss, negatively impacting training performance.

Lastly, all existing massive AI models are owned and trained by tech-giants through intensive computing resources, which are too expensive to be used by common companies or individuals. To reduce the cost of utilizing massive AI models, one promising approach is to deploy a massive AI model as a distributed system in a network environment (CN or RAN) where each network entity is embedded with a partition of the massive AI model can be afforded by the entity's computing resources.

Therefore, there is a need for systems and methods that obviate or mitigate one or more limitations of the prior art.

This background information is provided to reveal information believed by the applicant to be of relevance to the present disclosure. No admission is necessarily intended, nor should be construed that any of the preceding information constitutes prior art against the present disclosure.

### SUMMARY

Embodiments of the present disclosure provide a method and system for an augmented tree model for parallel and split learning (PSL). This method splits the AI model into several partitions, creating an augmented tree structure where each level corresponds to a partition, each branch node to an AI enabler, and each leaf node to a client. By using split learning, AI models, including neural networks, can be transformed into distributed models, with partitions ranging from the bottom level, including the input layer, to the top level, including the output layer. The augmented tree model, representing a proposed approach for actualizing a distributed AI model, enables simultaneous training of multiple copies of each partition level. Each node is a duplicate of its respective partition and needs a network entity for deployment.

An object of aspects of the present disclosure is to provide systems and methods for parallel and split learning. The Parallel and Split Learning (PSL) framework permits parallel training across all nodes at the same level within the augmented tree model, thus speeding up training. All branch nodes at the same level can execute forward propagation (FP) and back propagation (BP) in parallel once they receive the corresponding FP and BP data from their associated child and parent nodes, respectively. Furthermore, dynamic dropout control is introduced, where network link information is collected, and dropout rate indicators are configured. This allows for a local customization of the dropout decision, which then dictates which of one or more neurons or, one or more links should be temporarily muted or deleted for each training iteration. This realizes dynamic dropout while maintaining the average dropout rate indicated by the dropout rate indicator. Dynamic dropout improves the training performance of the augmented tree model by leveraging the outage or variations of network links between the network entities, naturally realizing random dropout, and preventing overfitting.

In accordance with another aspect of the present disclosure, there is provided a method for generating and instantiating an augmented tree model from an original artificial intelligence (AI) model including an input layer and an output layer. The method may be performed by a parallel and split learning (PSL) controller. The method includes dividing the original AI model into a plurality of partitions. The plurality of partitions include a bottom-level partition including the input layer, a top-level partition including the output layer, and a plurality of middle-level partitions including one or a plurality of intermediate layers between the input layer and the output layer. The divided original AI model forms an AI model. Also generating the augmented tree model of the AI model. The augmented tree model includes multiple levels, each level corresponding to one partition of the original AI model. The multiple levels include a top level, a bottom-level and one or multiple middle levels. The top level includes the top-level partition as a root node. The bottom level includes multiple copies of the bottom-level partition as leaf nodes. Each middle level includes multiple copies of the corresponding middle-level partition as branch nodes. The root node is linked with a plurality of branch nodes of a middle level adjacent to the top level. Each branch node is linked to a plurality of leaf nodes or a plurality of branch nodes in the lower level. The root node, the branch nodes, and the leaf nodes form a plurality of nodes of the augmented tree model. The method also includes instantiating one of the plurality of nodes of the augmented tree model into one of a plurality of entities of a network.

Embodiments further include receiving computing resources of the plurality of nodes of a network.

Embodiments further include receiving link information of a plurality of links connecting the plurality of nodes within the network.

In further embodiments, the division of the AT model is based on the computing resources of a plurality of network entities and computing load requirements of each of the plurality of partitions.

In further embodiments, the instantiating of the one of the plurality of nodes of the augmented tree model into one of the plurality of entities of the network is based on matching the computing resources of the one of the plurality of entities with the computing load requirements of the one of the plurality of nodes and on matching the link information of the plurality of links connected to the one of the plurality of entities to a communication requirement of the one of the plurality of nodes.

In further embodiments, the plurality of leaf nodes linking to the same branch node have similar available computing resources. It may be said that two nodes or computing entities may have similar available computing resources if the difference in computing resources of the two nodes or computing entities are within a pre-determined threshold of each other.

In further embodiments, a plurality of leaf nodes are able to communicate with each other to transmit parameters of the plurality of leaf nodes, or a plurality of branch nodes in a same level are able to communicate with each other to transmit parameters of the plurality of branch nodes.

Embodiments further include receiving a PSL request including partition requirements of the original AI model and augmented tree model requirements.

In further embodiments, the PSL request further includes model parameters of the original AI model including any of weights and bias of neurons and links, dropout rate associated with layers, and inter-layer dependency information of adjacent layers.

Embodiments further include receiving, by a branch node of the one or multiple middle levels or the root node, forward propagation (FP) data from a linked branch node of an adjacent lower middle level or a linked leaf node of an adjacent lower bottom level. Or receiving, by a branch node of the one or multiple middle level, backward propagation (BP) data from a linked branch node of an adjacent higher middle level or a linked root node of an adjacent higher top level. Or receiving, by a leaf node, backward propagation (BP) data from a linked branch node of an adjacent higher middle level. Or synchronizing, by a node, the parameters of the node to the nodes at the same level as the node, the node is one of the root node, branch node or leaf node.

In accordance with another aspect of the present disclosure, there is provided a method of dynamically dropout neuron or link update when training a distributed AI model, where the distributed AI model is split into a plurality of partitions, and at least two adjacent partitions of the plurality of partitions are deployed on different network entities interconnected by network links. The method is performed by a dynamic dropout controller. The method includes receiving a dynamic dropout control (DRC) request including information of a target node, where the target node is one of a plurality of nodes in a partition of the distributed AI model. Also sending, to a network entity deploying the target node, a request for outage probability information of links connecting the target node to the adjacent partition of the target node. Then receiving, from the network entity deploying the target node, the outage probability information and calculating, based on the outage probability information, a dropout rate indicator for the target node. The dropout rate indicator being used to determine an average dropout rate to be applied by the neurons on an input layer of the target node. Also sending, to the network entity deploying the target node, the dropout rate indicator, where the dropout rate indicator is configures the target node to execute dynamic dropout when training the distributed AI model.

In further embodiments, the average dropout rate includes a set of available values.

In further embodiments, the dropout rate indicator is associated with the link connecting the target node to the adjacent partition in the distributed AI model.

In further embodiments, the dropout rate indicator is calculated to meet a dropout requirement of the distributed AI model.

In further embodiments, the distributed AI model includes an augmented tree model.

In further embodiments, the outage probability information includes the outage probability information of links connecting the target node to a child node of the target node in the augmented tree model.

In further embodiments, the dropout rate indicator is associated with one of the links connecting the target node to the child node of the target node in the augmented tree model.

In accordance with another aspect of the present disclosure, there is provided an apparatus for generating and instantiating an augmented tree model from an original artificial intelligence (AI) model. The apparatus includes a parallel and split learning (PSL) controller including a processor and a tangible, non-transitory computer readable memory configured to perform a method as defined in any one of aforementioned methods.

In accordance with another aspect of the present disclosure, there is provided a system for generating and instantiating an augmented tree model from an original artificial intelligence (AI) model. The system includes one or more computers each including a processor and a tangible, non-transitory computer readable memory. The computer readable memory includes instructions recorded thereon to be performed by the one or more computers of the system to carry out a method as defined in any one of aforementioned methods.

In accordance with another aspect of the present disclosure, there is provided a tangible, non-transitory computer readable memory having instructions recorded thereon to be performed by at least one processor to carry out a method as defined in any one of aforementioned methods.

Embodiments of the present disclosure may provide technical advantages or benefits.

Embodiments address critical challenges in the realm of parallel split learning implementation. Through the development of an augmented tree model, it allows for parallel split learning while taking into account new parameters like inter-layer dependencies during the AI model splitting process. The augmented tree model enables the transformation of any AI model, including neural networks, into distributed AI models by dividing the model into ranked partitions, from the input layer at the bottom to the output layer at the top. This model utilizes physical network entities for the implementation of its logical concepts.

Embodiments introduce a dynamic method for dropout rate customization, which adjusts according to network connection status. This strategy capitalizes on network connection outages to naturally achieve random dropout, which subsequently enhances training speed and helps avoid overfitting. Moreover, the implementation network can accommodate not just the augmented tree model, but also other distributed AI model variants. Importantly, the dynamic dropout technique extends to all kinds of distributed AI models implemented within the network. As a result, the present application effectively leverages network-enabled distributed resources for large-scale model training within the NET4AI network.

Embodiments provide a cost-effective approach to training large AI models within networks, potentially accelerating model training in NET4AI. It has significant implications for industry standards, as split learning and distributed learning are set to form the foundation of future standards by entities like 3GPP and others. Consequently, this approach is well-positioned to gain a significant share of the massive model training market, which is presently dominated by AT giants.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which;

FIG. 1 shows an AI model splitting in parallel and split learning (PSL) framework, according to an embodiment.

FIG. 2 shows an augmented tree model in PSL framework, according to an embodiment.

FIG. 3 shows an example of the PSL framework, according to an embodiment.

FIG. 4 shows a flowchart of augmented tree model generation and instantiation, according to an embodiment.

FIG. 5 shows a structure of an augmented tree model PSL training, according to an embodiment.

FIG. 6 shows a comparison of the convergence speed analysis between cluster-based SL training and augmented tree model PSL training.

FIG. 7 shows a flowchart of dynamic dropout control, according to an embodiment.

FIG. 8 shows an electronic device, according to an embodiment.

It will be noted that throughout the appended drawings, like features are identified by like reference numerals.

### DETAILED DESCRIPTION OF THE ILLUSTRATIVE EMBODIMENTS

Unless defined otherwise, all technical and scientific terms used herein have the same meaning as commonly understood by one of ordinary skill in the art to which this disclosure belongs.

Generally, an artificial intelligence (AI) model can be divided into two primary components: an encoder and a classifier. The encoder, comprising the lower layers, is responsible for capturing fine-scale, low-order features and is typically implemented on devices or client-side with limited processing capabilities. In contrast, the classifier encompasses the upper layers, capturing coarse-scale, high-order features, and is usually implemented on the cloud or server-side, where processing capabilities are more robust.

Split Learning (SL), as used herein, refers to a fundamental technique enabling the distributed deployment of massive AI models. For instance, an original AI model can be split into an encoder (partition 1) and a classifier (partition 0). The encoder includes the input layer and possibly one or more hidden layers (layers between the input layer and the output layer) after the input layer. The classifier includes the remaining hidden layers (if any) and the output layer.

Generally, the encoder captures low-order or coarse-scale features of the original AI model, while the classifier captures high-order or fine-scale features and tends to be goal-specific. The layer that splits the original AI model into an encoder and a classifier is referred to as the cutting layer. The encoder contains the cutting layer (as the output layer of the encoder), while the classifier contains the layer after the cutting layer (as the input layer of the classifier). The encoder and the classifier of an AI model can be instantiated in different entities (e.g., server, device), respectively. The intermediate data (e.g., forwarding training/inferencing data, back-propagation data) for AI model training or inferencing, which interacts between the encoder and classifier, is transmitted via network connections/links.

In a split learning model involving multiple encoders or clients, the training process must be executed sequentially among clients, typically following five key steps. First, encoder or client X provides intermediate results (forward propagation) to the classifier. Second, the classifier sends back the gradient through backpropagation. Third, encoder or client X synchronizes its weights with encoder or client Y, facilitating communication between the two. Fourth, encoder or client Y then transmits its intermediate results (forward propagation) to the classifier. Finally, the classifier sends the gradient back to encoder or client Y via backpropagation. This sequential process ensures that all encoders or clients contribute to the model's learning, ultimately producing a more comprehensive and accurate AI model.

Cluster-based parallelization, as used herein, refers to an advanced technique employed in split learning training to enhance efficiency. This approach involves categorizing client devices into one or more clusters based on similarities in resource availability and network conditions. Within each cluster, devices undergo parallel training, while sequential training takes place across different clusters. As the training progresses, the preceding cluster updates its partition parameters and shares them with all devices in the subsequent cluster. This enables the latter cluster to carry out parallel training effectively, incorporating the updated information. Overall, this method optimizes the split learning process, leading to improved performance and faster training times.

The present disclosure provides a method and system for an augmented tree model for parallel and split learning (PSL). The method and system can leverage network-enabled distributed resources to train extremely large models and minimize training latency.

In relation to the present disclosure, the augmented tree model is generated by splitting the AI model into multiple partitions so that the augmented AI model can be expressed by an augmented tree structure, with each level of the tree corresponding to a partition. In the augmented tree model, each branch node corresponds to an AI enabler, and each leaf node corresponds to a client. Furthermore, the server-side partition can be deployed in the network, and parallelization can be enabled.

In general, there are two types of logic link in an augmented tree: first, the link between nodes of a same partition (level) which is used to synchronize their parameters; and second, the link between nodes of different partitions (levels) which is used to transmit forward-propagation (FP) and back-propagation (BP) data. FP data, as used herein, refers to the process of moving calculations forward in the model, from input to output, to generate a prediction. On the other hand, BP data refers to a method used in neural networks to calculate a gradient that is needed in the calculation of the weights to be used in the network. Parallel training, as used herein, refers to the process of training different nodes simultaneously, which can make the training process faster and more efficient.

In embodiments, the relationship among the distributed AI model, the augmented tree model, and the network implementing them is such that:

First, the transformation of any AI model, including a neural network, into a distributed AI model may be facilitated by employing the split learning technique. This method involves dividing the AI model into multiple partitions that are ranked sequentially from the bottom level, which includes the input layer of the AI model, to the top level, which includes the output layer. The partition of a distributed AI model, positioned anywhere from zero to multiple tiers between the bottom and top-level partitions, constitutes a logical or model concept and demands a physical network entity for implementation.

Second, the augmented tree model represents a suggested approach for instantiating a distributed AI model. This is accomplished by concurrently training multiple copies of each partition level. In the augmented tree model, all nodes, whether they are leaf nodes, root nodes, branch nodes, child nodes, or parent nodes, are duplicates of their respective partitions. Each node in the augmented tree model, like the partition in a distributed AI model, is also a logical or model concept and requires a physical network entity for its deployment.

Lastly, the network has the capacity to implement not just the augmented tree model but also other variants of distributed AI models within its entities. It's important to note that the application of dynamic dropout is not limited to the augmented tree model but extends to all forms of distributed AI models implemented in the network.

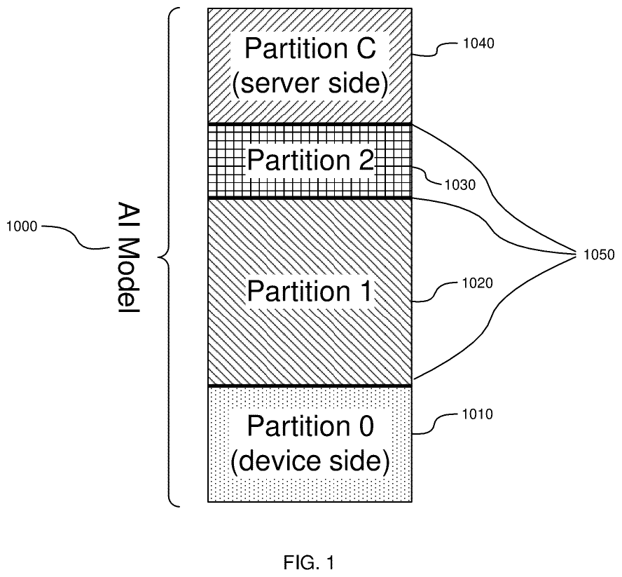

FIG. 1 illustrates an AI model splitting in a Parallel and Split Learning (PSL) framework, according to an embodiment. In parallel and split learning (PSL), an original AI model 1000 can be split into multiple partitions. The bottom-level partition 1010 (e.g., partition 0) includes the input layer and possibly one or more hidden layers following the input layer of the original AI model, which may correspond to the encoder in a traditional Split Learning (SL) model. The top-level partition 1040 (e.g., partition C) includes the output layer and possibly one or more hidden layers before the output layer of the original AI model, which may correspond to the output part of the classifier in a traditional SL model. Each of the intermediate partitions, such as partition 1 1020 or partition 2 1030 between partition 0 1010 and partition C 1040 may include one or multiple hidden layers of the original AI model, which corresponds to one part of classifier in a traditional SL model. The number of intermediate partitions can vary from 0 to a total number of hidden layers in the original model according to different split decisions.

As used herein, in terms of the forward-propagation (FP) direction, the adjacent partition preceding a given partition is referred to as a preceding partition, while the adjacent partition following it is referred to as a following partition (e.g., for partition 1, partition 0 is the preceding partition, and partition 2 is the following partition). The layer that splits a partition with the following partition is referred to as the cutting layer 1050, which is contained in the partition as the output layer.

Unlike a traditional SL model, which may only have one cutting layer, the PSL framework may include one or multiple cutting layers 1050 to split the original AI model. Therefore, PSL can split the original AI model into more fine-grained partitions, which each require fewer computing resources than the coarse-grained classifier in traditional SL.

Embodiments of the present disclosure enable parallel training of the partitions in the PSL framework. In the PSL framework, the original AI model can be instantiated as an augmented tree model composed of partitions (of the original AI model) instantiated on distributed network entities.

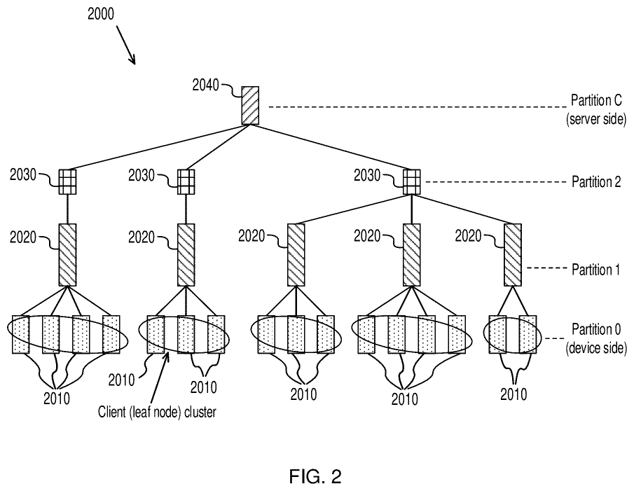

The augmented tree model can be expressed as a hierarchical augmented tree 2000, as shown in FIG. 2. Each level of the tree 2000 corresponds to a partition of the original AI model, and each node in the level corresponds to a copy of a partition. Notably, a copy of a partition should have an identical model structure to the partition's model structure. In an augmented tree model, the root node 2040 may be a copy of, or may be based on, the partition C 1040, each leaf node 2010 may be a copy of, or may be based on, the partition 0 1010, and each branch node 2020 or 2030 may be a copy of, or may be based on, the partition corresponding to the level of the branch node.

The root node 2040 or each branch node may have one or more child nodes, which are copies of the preceding partition. Each leaf node or each branch node has a parent node, which is the copy of the following partition. In an augmented tree model, all leaf nodes should have the same depth, which ensures that the input data from any leaf node can traverse all partitions of the original AI model until it reaches the output layer of partition C.

In the context of an augmented tree model, the root node 2040, which may be a replica of partition C 1040, can be implemented on the server side. Similarly, leaf nodes 2010, which are duplicates of partition 0 1010, can be instantiated on the side of the device or client. The branch nodes such as 2030 or 2020, which are replicas of other partitions 1020 or 1030, can be implemented on various entities in the network.

In some embodiments, the network-operated entities can also be used to instantiate leaf nodes. If a scenario arises where one or more clients fall into the same category or cluster, the leaf nodes instantiated on the clients should all link back to the same parent node in the augmented tree model 2000.

In embodiments, the edges, lines, or connections in the augmented tree model 2000 are capable of interactions of intermediate data between child and parent nodes. The intermediate data includes forward propagation (FP) or inferencing data, and back propagation (BP) data.

In embodiments, this intermediate data is instantiated via network connections or links. These network connections or links can also exist between nodes at the same level. This may be done to synchronize or make uniform the updated weights and biases of each replica of the partition in parallel training.

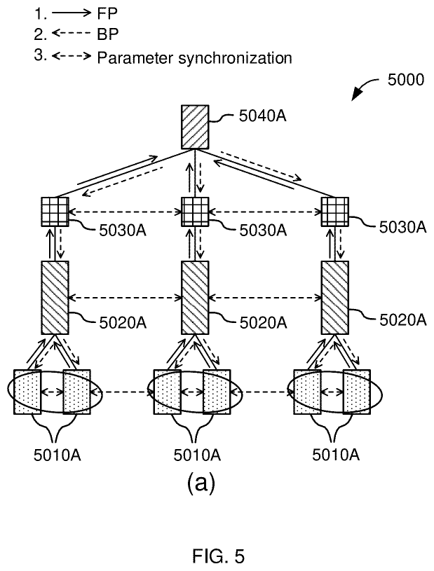

In contrast with the traditional SL model which only allows parallel training of the client-side partition (encoder), the augmented tree model in PSL framework enables the paralleling training of both the client-side partition (partition 0) and higher-level partitions. As such, the training efficiency can be further improved in the augmented tree model as described with respect to FIG. 5.

Embodiments include a method of parallel and split learning (PSL) framework (i.e., an augmented tree model). This framework serves a dual or multiple purpose. It enables the generation and instantiation of an augmented tree model, as well as the dynamic customization and configuration of the instantiated partitions, which are represented as nodes in the augmented tree model. Furthermore, this method leverages network-enabled distributed resources to train highly extensive models, thereby minimizing training latency.

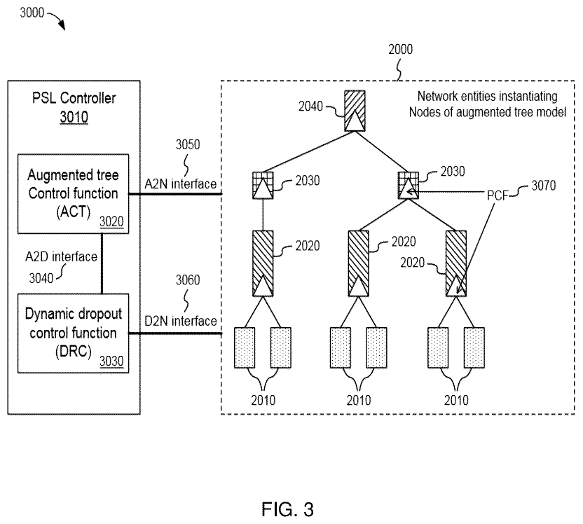

FIG. 3 shows an example of the PSL framework 3000, according to an embodiment. PSL framework 3000 includes a PSL controller 3010 and the partition customization function (PCF) 3070 on each entity instantiating the node(s) of the augment tree model.

The PSL controller 3010, as used herein, may be a logic controller which can be instantiated in either a centralized way (e.g., in a Cloud environment or on a server) or on distributed network entities. In some embodiments, all, one, or multiple functionalities composing the PSL controller 3010 can be instantiated as the internal functionality of a network control module or function, for example, a service control function (SCF) in NET4AI, a system architecture intended to support computing services, such as AI computing services.

Referring to FIG. 3, the PSL controller 3010 can include an augmented tree model control function (ATC) 3020. Notably, the ATC 3020 can partition the original AI model to generate the augmented tree model. This process is based on features of the original AI model and the availability of computing resources within the network. Moreover, it determines the network's instantiation decisions of the augmented tree model.

In embodiments, the PSL controller 3010 can include dynamic dropout control function (DRC) 3030. Random dropout is commonly applied in large model training to prevent overfitting. This technique randomly silences or “mutes” a subset of neurons in each layer during each batch training, thereby disrupting the forward propagation (FP) and back propagation (BP) of these neurons. Within the PSL framework 300, unstable network connections (such as with wireless connections) can naturally facilitate random dropouts by losing the FP or BP data from the preceding or following partitions. To implement this network connection-based random dropout, the DRC 3030 may set a dropout rate indicator and send this indicator to each entity instantiating a node of the augmented tree model.

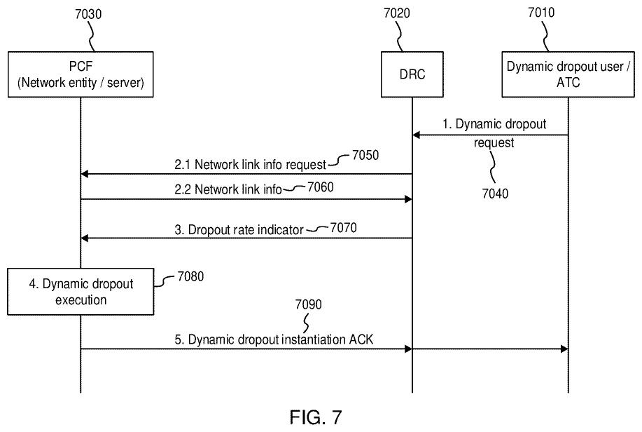

In embodiments, the PCF 3070 may be instantiated in each entity instantiating node (for example, in each of 2020, 2030, 2040) of the augmented tree model. Notably, PCF is not required in the leaf nodes. The PCF 3070 can receive a dropout rate indicator from DRC 3030, then, locally customize the real-time dropout decision according to network conditions and the received dropout rate indicator. This is further described in FIG. 7.

Referring to FIG. 3, the PSL framework 3000 includes the following three interfaces. ATC-to-DRC interface (A2D interface) 3040, as used herein, refers to the communication channel between the Augmented Tree Model Control function (ATC) 3020 and the Dynamic Dropout Control function (DRC) 3030 within the Parallel and Split Learning (PSL) framework. It allows these two components to exchange information, such as dropout rates and model partition details, to improve the overall effectiveness and efficiency of the learning process.

ATC-to-Network entity interface (A2N interface) 3050, as used herein, refers to the communication pathway that connects the ATC 3020 with the network entities (including server and client in some embodiments) in which the partitions of the augmented tree model are instantiated. This interface allows the ATC to provide instructions about the model's partitioning and control their instantiation on the network entities. In some embodiments, the A2N interface 3050 can be realized by the interface between data plane network entities and the network controller. As such, the messages related to augmented tree model generation and embedding are transmitted via the A2N interface.

The DRC-to-Network entity interface (D2N interface) 3060, as used herein, facilitates communication between the Dynamic Dropout Control function (DRC) 3030 and the network entities. These entities include clients in certain embodiments and instantiate the branch or root nodes of the augmented tree model within the Parallel and Split Learning (PSL) framework. The D2N interface 3060 allows the DRC to distribute dropout rate indicators effectively to the entities embodying a node of the augmented tree model. This connectivity aids in proficiently managing random dropout processes throughout the network entities. In certain embodiments, the D2N interface 3060 is realized through the connection between data plane network entities and the network controller. Consequently, messages related to dynamic dropout control are transmitted via the D2N interface 3060, ensuring a well-coordinated and effective dropout process.

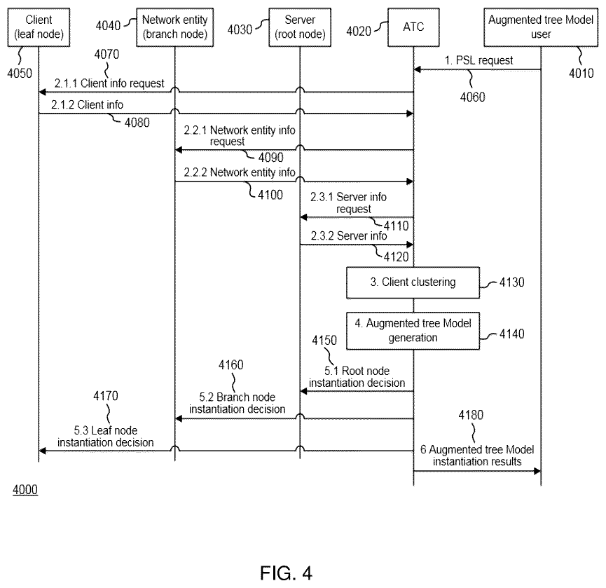

FIG. 4 shows a process flowchart of augmented tree model generation and instantiation, according to an embodiment. A PSL request is provided or sent from an augmented tree model user 4010 to the ATC 4020 to trigger the augmented tree model generation and instantiation via step 4060. In embodiments, the augmented tree model user 4010 can be either a network internal functionality (e.g., a task control function of NET4AI service), or a third-party application. The PSL request may include original AI model information, partition requirements, augmented tree model requirements, etc.

In embodiments, the original AI model information typically includes the structure information of the original AI model, and the (optional) model parameters of the original AI model. For example, the model parameters of the original AI model may include (1) weights and bias on neurons and links of the original AI model, (2) dropout rate associated with each layer of the original AI model, (3) inter-layer dependency info of adjacent layers (e.g., an indicator associated with each layer to indicate whether the layer can be chosen as the cutting layer) which can be obtained from pre-knowledge of the original AI model. In some embodiments, where the model parameters are not provided in original AI model information, the ATC can determine the model parameters of the original AI model according to pre-defined knowledge or algorithms.

In embodiments, the partition requirements include the requirements and constraints for splitting the original AI model into partitions, such as (but not limited to) a maximum or a minimum number of partitions, a maximum or a minimum size. In other words, a maximum or a minimum number of layers in the partition and a maximum or a minimum number of neurons in each layer of the partition, of partition 0, partition C, and other partitions.

In embodiments, the augmented tree model requirements may include the requirements and constrains for the augmented tree model generation and instantiation, such as (but not limited to) a maximum number of copies of the corresponding partition in each level, a minimum or a maximum number of client in a cluster, a maximum number of child nodes for a branch node or the root node, a minimum computing resource requirement for an entity, a server, or a device to instantiate a node, a network location or an address of the server to instantiate the root node. Notably, the augmented tree model requirements may also include the performance requirements of the augmented tree model, such as (but not limited to) maximal convergence time threshold.

Following step 4060, after receiving the PSL request, the ATC 4020 interacts with all available devices, entities, and servers 4030 in the network (via A2N interface) to collect the available computing resources and link information of the network, which are used to generate and instantiate the augmented tree model.

In embodiments, the process of entity information collection may include client information collection, network entity information collection, and server information collection. It typically starts with client information collection, for example, as illustrated by step 4070 and 4080 in FIG. 4.

Referring to FIG. 4 for the client information collection, the ATC 4030 sends client info request(s) to all available device(s) 4050 via step 4070. After receiving the client info request, each device 4050 sends the client info back to the ATC 4020 via step 4080. In embodiments, the client info includes the information of available computing resources on the device, and the physical location or network address of the device.

Referring to FIG. 4 for the network information collection, the ATC 4020 sends network entity info request(s) to all available network entities 4040 via step 4090. After receiving the network entity info request, each network entity 4040 sends the network entity info back to the ATC 4020 via step 4100. In embodiments, the network entity info includes the information of available computing resources on the network entity, and the physical location or network address of the network entity.

In some embodiments where the network entity can sense the information of the connected network links (e.g., outage probability, available bandwidth, wireless channel pathloss), the information of the connected network links of the entity is also included in the network entity info sending to the ATC.

Referring to FIG. 4 for the server information collection, the ATC 4020 sends server info request(s) to all available server(s) 4030 via step 4110. After receiving the server info request, each server 4030 sends the server info back to the ATC 4020 via step 4120. In embodiments, the server info includes the information of available computing resources on the server, and the physical location or network address of the server.

In embodiments of the process of client clustering, at step 4130, ATC 4020 classifies clients into different clusters (by pre-defined clustering algorithms in ATC), according to the received client info at step 4080. Notably, the ATC 4020 ensures that the clients in the same cluster have similar computing capabilities within a pre-defined threshold.

In embodiments of the process of augmented tree model generation, at step 4140, the ATC 4020 generates the augmented tree model (with information) and determines the augmented tree instantiation decision by a pre-defined algorithm or algorithms or an AI solution or AI solutions, based on the received client info, network entity info, server info, and the PSL request.

Accordingly, the information of the generated augmented tree model 2000 may include the hierarchical augmented tree structure information (i.e., an ID of each node in the tree, height of the tree, number of nodes in each level, parent node and child node IDs for each node in the tree). Furthermore, the information of the generated augmented tree model may include information of the partition associated with each level of the tree (i.e., information of partition structure, parameters of the partition including weights and bias on neurons and links in the partition, dropout rate associated with each layer in the partition).

Furthermore, the augmented tree instantiation decision determined at step 4140 associates the ID or network address or location of each device, network entity, or server with the ID of augmented tree node (copy of the partition) to be instantiated on the device or network entity or server.

In embodiments of the process of augmented tree model instantiation, one or more root node instantiation decisions, one or more branch node instantiation decisions and one or more leaf node instantiation decisions are communicated, after obtaining the augmented tree instantiation decision solving a joint optimization problem (denoted by equation (1)) described below.

Referring to FIG. 4, at step 4150, the ATC 4020 sends a root node instantiation decision to the server 4030 instantiating the root node (via A2N interface). In embodiments, the root node instantiation decision includes the information of the partition C, and the IDs or network addresses or locations of network entities instantiating the child node or nodes of the root node. According to the received root node instantiation decision, the server instantiates the copy of partition C and configures interfaces or connections to the network entities instantiating the child nodes of the root node. In some embodiments, the server 4030 may send an acknowledge (ACK) message to the ATC 4020 after successfully instantiating the copy of partition C and configuring the interfaces or connections.

At step 4160, the ATC 4020 sends a branch node instantiation decision to the network entity instantiating the associated branch node (via A2N interface). In embodiments, the branch node instantiation decision includes the information of the partition associated with the level of the branch node, and the IDs or network addresses/locations of clients, network entities, or server instantiating the child nodes, parent node, and other branch nodes in the same level of the branch node. According to the received branch node instantiation decision, the network entity instantiates the copy of the partition and configures the interfaces or connections to the clients, network entities, or server instantiating child nodes, a parent node, and other nodes in the same level of the branch node. In some embodiments, the network entity may send an ACK message to the ATC after successfully instantiating the copy of the partition and configuring the interfaces or connections.

At step 4170, the ATC 4020 sends a leaf node instantiation decision to the client instantiating the leaf node (via an A2N interface). In embodiments, the leaf node instantiation decision includes the information of the partition 0, the IDs or network addresses or locations of network entities or clients instantiating the parent node of the leaf node and other leaf nodes, as well as the ID of the cluster with which the client is associated. According to the received leaf node instantiation decision, the client instantiates the copy of partition 0 and configures the interfaces or connections to the network entities or clients instantiating the parent node of the leaf node and other leaf nodes. In some embodiments, the client may send an ACK message to the ATC after successfully instantiating the copy of partition 0 and configuring any interfaces or connections.

Afterwards, for the process of augmented tree model instantiation result ACK, at step 4180, the ATC 4020 may send the augmented tree model instantiation result to the augmented tree model user 4010 to indicate the successful instantiation of the augmented tree model (in other words, acknowledging the completion of the augmented tree model instantiation). In embodiments, the augmented tree model instantiation result may include the information of the generated augmented tree model and the augmented tree instantiation decision.

As mentioned above, in some embodiments, the ATC can generate the augmented tree model and determine the augmented tree instantiation decision by solving a joint optimization problem (denoted by equation (1)) with the objective to minimize the overall training latency of the augmented tree model. For example, the joint optimization problem can be expressed below:

$${min}_{{P}_{0} , {P}_{i} , {a}_{i , s , k}} {max}_{s ∈ S} [ \frac{{P}_{0}}{{min}_{k ∈ {K}_{s}} {a}_{0 , s , k}} + \frac{{C}_{0}}{{min {b}_{0 , s , k}}_{k ∈ {K}_{s}}} + {\sum }_{i = 1}^{\vert I \vert} ( \frac{{P}_{i}}{{min}_{k ∈ {K}_{s}} {a}_{i , s , k}} + \frac{{C}_{i}}{{min {b}_{i , s , k}}_{k ∈ {K}_{s}}} ) ]$$

$$such that , \frac{{P}_{i}}{{a}_{i , s , k}} \geq {\sum }_{k} \frac{{P}_{i - 1}}{{a}_{i - 1 , s , k}} ∀ s ∈ S$$

$$1 \leq \vert {K}_{s} \vert \leq \vert {A}_{i} \vert ∀ s ∈ S , i ∈ I$$

In the optimization problem, i indicates the i-th level of the augmented tree model, s indicates the cluster of nodes with the same parent node, k indicates the k-th node in a cluster s, |Kₛ| indicates the number of node in the cluster s which is constrained by the maximal allowed child node number |Aᵢ| for the level of the parent node. In embodiments, the decision parameters may include Pᵢ (including P₀) which represents the computing loads at partition 0 and other partitions of the original AI model, respectively, and furthermore a_{0,s,k} which represents the available computing resources on a network entity or client.

In embodiments, the constrains may include the communication load Cᵢ associated with each partition Pᵢ, the available communication bandwidth b_{i,s,k} of the link between a node and the parent node of the node, the inter-layer dependency constrains (can be obtained in PSL request), and the computing capacity compatibility between a node and the child nodes of the node (represented by the first constrain in the optimization problem). According to the computing capacity compatibility constrain, a branch node with child nodes should have more computing resources compatible with the computing resources of all child nodes, e.g., for one branch node with 4 child nodes, if each leaf node uses one time unit to process one FP or BP, the branch node must be able to process four FP or BP within one time unit to prevent delay in parallel training of the augmented tree model.

In embodiments, computing resources of a node or computing entity may include an amount, a size, or a volume of computing resources such as processing power or speed, network speed, I/O speed, storage speed or amount, etc. Similarly, it may be said that two nodes or computing entities may have similar available computing resources if the difference in computing resources of the two nodes or computing entities are within a pre-determined threshold of each other.

In practical scenarios, the above joint optimization problem may be cast in varying forms, as long as it includes the following features or parameters with an objective to minimize the overall training latency of the augmented tree model.

The computation load at each partition of the AI model, such as Pᵢ and P₀ and the available computing resources on each network entity or client implementing the partition or partitions of the AI model, represented as a_{i,s,k} are two significant optimization variables to be determined for achieving the optimization objective. Since the original AI model is pre-determined, each model partitioning or splitting decision can be mapped to a set of partitions' computing loads. Hence, the computation load at each partition is equivalent to the AI model partitioning or splitting decision.

In other words, essential parameters for formulating and solving the joint optimization problem include the communication load associated with each partition (e.g., Cᵢ), the available communication bandwidth of the link between a node and its parent node (e.g., b_{i,s,k}), and the inter-layer dependency constraints, which are implied in the available partitioning or splitting choices of the AI model.

The constraints associated with the joint optimization problem include a branch node with child node or nodes should possess more computing resources compatible with the computing resources of all child node or nodes. For one branch node with four child nodes, if each leaf node uses one time unit to process one FP or BP, the branch node must be capable of processing four FP or BP within one time unit to avoid delay in parallel training of the augmented tree model. Another constraint is that the number of nodes in a cluster is constrained by the maximal allowed child node number of their parent node's level, represented by the second constraint in the optimization problem.

The Parallel and Split Learning (PSL) framework 5000, as illustrated in FIG. 5, expedites training speed by allowing parallel training across all nodes on the same level within the augmented tree model. This contrasts with cluster-based parallel training for split learning. As earlier mentioned, for cluster-based parallel training for split learning, each cluster may conduct one training iteration in parallel. That is, all clients simultaneously execute a training iteration's forwarding-propagation (FP) and back-propagation (BP), then synchronize the encoder parameters (for instance, by averaging all clients' encoder parameters). The training is sequential between clusters: once a cluster completes a parallel training iteration, it updates the synchronized encoder parameters to all devices in the subsequent cluster. This cluster then conducts its parallel training iteration, and this process is repeated until the split learning (SL) model converges. Embodiments can function effectively using the Parallel and Split Learning (PSL) framework 5000 as illustrated in FIG. 5.

As depicted in FIG. 5, except for the top layer that only has the root node, all branch nodes at the same level can execute FP and BP in parallel once they receive the corresponding FP and BP data from their associated child and parent nodes, respectively. Moreover, all leaf nodes linked to different clusters can conduct FP and BP in parallel, and after one training iteration, all branch nodes synchronize their local partition parameters with other branch nodes at the same level and all leaf nodes synchronize their local partition parameters with other leaf nodes (indicated by double arrow dotted lines).

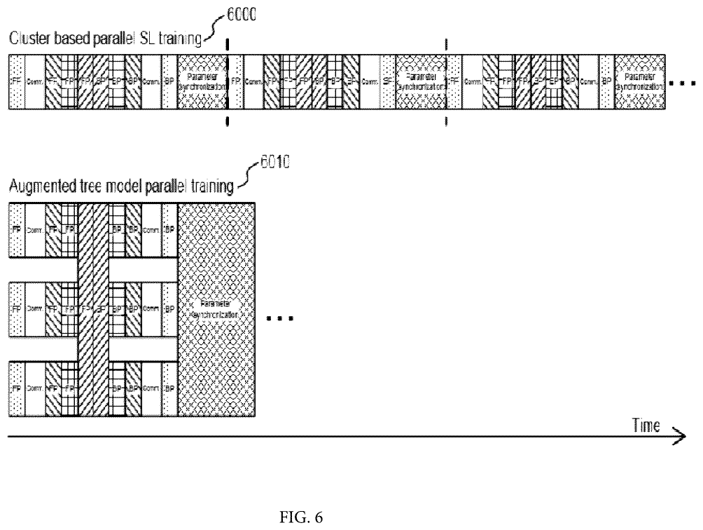

FIG. 6 compares the training time consumptions of the cluster-based SL training and the augmented tree model parallel training (in other words, a convergence speed analysis for cluster based parallel SL training and augmented tree model parallel training). Both models use the same client clustering result and partition decision to ensure a fair comparison.

As FIG. 6 illustrates, the parameter synchronization time in the augmented tree model parallel training 6010 is longer than in the cluster-based parallel SL training 6000. This difference arises from the additional parameter synchronization data exchange between branch nodes. However, due to the sequential training across different clusters, the cluster-based parallel SL training 6000 requires three rounds of FP/BP time to complete the training of all clients classified into three clusters. In contrast, the augmented tree model parallel training 6010 only needs one round of FP/BP time as all clients in the three clusters are trained simultaneously. As a result, the cluster-based parallel SL training 6000 can consume more training time than the augmented tree model parallel training.

FIG. 7 shows a flowchart of dynamic dropout control, according to an embodiment where the dynamic dropout control is conducted via the following procedures or steps.

Initially, in step 7040, a Dynamic Dropout Request is initiated, containing the IDs or network locations or addresses of the target network entities or servers to apply dynamic dropout. In embodiments, the targeted network entity or server instantiates a node of the augmented tree model, known as the target node. The ATC 7010 or dynamic dropout user sends the dynamic dropout request to the DRC 7020 via the A2D interface, in step 7040. In some embodiments, a dynamic dropout user, which could be either a network internal functionality or a third-party application, can also send the dynamic dropout request to the DRC 7020.

The next phase, step 7050, is the Network Link Information Collection. After receiving the dynamic dropout request, the DRC 7020 sends a network link info request (via the D2N interface) to each target network entity or server 7030 to execute dynamic dropout in step 7050. Each target network entity/server receiving this request sends the network link info back to the DRC 7020 in step 7060. In certain embodiments, the network link info includes the statistical outage probability of network links connecting the target network entity or server with the network entities instantiating the child nodes of the target node.

The third step, step 7070, involves Configuring Dropout Rate Indicators. Based on the received network link info from each target network entity or client, the DRC 7020 calculates the dropout rate indicators for each target node. This indicator is used to determine the average dropout rate to be applied by the node on the input layer and could be a value or a set of available values used as the average dropout rate. Notably, each physical link corresponds to one dropout rate indicator. For multiple child nodes sharing the same physical link, one corresponding dropout rate indicator is assigned to the physical link. The dropout rate indicator is calculated to ensure both overall AI model dropout requirements, a known feature of the original AI model, and to ensure the corresponding link can support the dropout rate. For example, a link with a statistical outage probability of 0.3 cannot support a dropout rate >0.7 indicated in the dropout rate indicator. In certain embodiments, the dropout rate indicator can be calculated using pre-defined algorithms or schemes. After determining the dropout rate indicators for each target node, the DRC 7020 sends the associated dropout rate indicators to each target entity or server (via the D2N interface) in step 7070.

The fourth procedure, step 7080, is Dynamic Dropout Execution. Given the received dropout rate indicators and the sensed real-time physical link status, the PCF instantiated on each target network entity or server 7030 can locally customize the dropout decision at step 7080. This decision dictates which neurons or links should be temporarily muted or deleted for each training iteration, thereby realizing the dynamic dropout while ensuring the average dropout rate indicated by the dropout rate indicator.

Finally, in step 7090, the Dynamic Dropout Instantiation Acknowledgement (ACK) takes place. In some embodiments, the PCF 7030 executing dynamic dropout may send a dynamic dropout instantiation ACK to the DRC 7020 to indicate the successful execution of dynamic dropout on the target network entity or server in step 7090. After receiving the dynamic dropout instantiation ACK, the DRC 7020 may forward the dynamic dropout instantiation ACK to the ATC or dynamic dropout user who sent the dynamic dropout request 7010.

Compared with traditional random dropout with fixed dropout rate on each layer, the dynamic dropout leverages the outages or variations of network links between the network entities/server instantiating the nodes of augmented tree model to naturally realize random dropout, which prevents overfitting (original purpose of random dropout) and improve the training performance of the augmented tree model (if applying traditional random dropout in augmented tree model training, the unexpected FP and BP data loss of not muted neurons or links can deteriorate the training performance).

Embodiments of the present disclosure may address practical issues within the realm of parallel split learning implementation. For instance, an augmented tree model, as used herein, is designed to enable parallel split learning while considering new parameters such as inter-layer dependencies when splitting the AI model. Additionally, a method for dynamic dropout rate customization, as used herein, is capable of adjusting in line with network connection status.

These embodiments present a range of technical advantages or benefits. Primarily, they allow the leveraging of network-enabled distributed resources for training vast models within the NET4AI network. Subsequently, they utilize network connection outages between partitions to naturally achieve random dropout, thereby accelerating training speed and aiding in the prevention of overfitting.

From a commercial standpoint, these methods provide a cost-effective strategy for training large models within networks and speed up AI model training in NET4AI. As for industry standards, split learning and distributed learning are integral components for the future of entities such as 3GPP and others. In other words, addressing standards, split learning and distributed learning will form the bedrock of future standards by entities such as 3GPP and others. The commercial appeal of these methods lies in their cost-effectiveness for training large models in networks and their potential to speed up AI model training in NET4AI. These methods could seize a share of the massive model training market, which is currently controlled by AI giants.

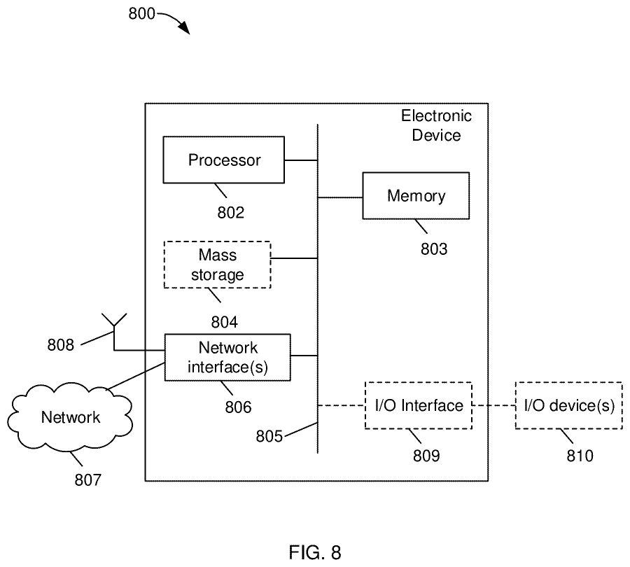

FIG. 8 illustrates an apparatus such as an electronic device 800, according to an embodiment, that may perform any or all of operations of the methods and features explicitly or implicitly described herein, according to one or more aspects of the disclosure.

As shown, the apparatus 800 may include a processor 802, such as a Central Processing Unit (CPU) or specialized processors such as a Graphics Processing Unit (GPU) or other such processor unit, memory 803, non-transitory mass storage 804, input-output (I/O) interface 809, and network interfaces 806, all of which may be communicatively coupled via bi-directional bus 805. I/O interface 809 may be connected to various I/O devices 810 as required by each configuration of electronic device 800. Similarly, network interfaces 806 may interface to various networks, for example network 807.

According to certain aspects, any or all of the depicted elements may be utilized, or only a subset of the elements. Further, components of electronic device 800 may contain multiple instances of certain elements, such as multiple processors, memories, or transceivers. Also, elements of the hardware device may be directly coupled to other elements without the bi-directional bus 805. Additionally, or alternatively to a processor 802 and memory 803, other electronics, such as integrated circuits or ASICs, may be employed for performing the required logical operations.

Memory 803 may include any type of non-transitory memory such as static random-access memory (SRAM), dynamic random-access memory (DRAM), synchronous DRAM (SDRAM), read-only memory (ROM), any combination of such, or the like. The mass storage element 804 may include any type of non-transitory storage device, such as a solid-state drive, hard disk drive, a magnetic disk drive, an optical disk drive, USB drive, or any computer program product configured to store data and machine executable program code. According to certain aspects, memory 803 or mass storage 804 may have recorded thereon statements and instructions executable by the processor 802 for performing any of the aforementioned method operations described herein.

Embodiments of the present disclosure can be implemented using electronics hardware, software, or a combination thereof. Some embodiments may be implemented by one or multiple computer processors executing program instructions stored in memory. In some embodiments, the present application is implemented partially or fully in hardware, for example using one or more field programmable gate arrays (FPGAs) or application specific integrated circuits (ASICs) to rapidly perform processing operations.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the present application are examples and can be varied in many ways. Such present or future variations are not to be regarded as a departure from the spirit and scope of the application, and all such modifications as would be obvious to one skilled in the art are intended to be included within the scope of the following claims.

What is claimed is:

1. A method for generating and instantiating an augmented tree model from an original artificial intelligence (AI) model, the method being performed by a parallel and split learning (PSL) controller, the method comprising:
dividing the original AI model into a plurality of partitions, the plurality of partitions including a bottom-level partition including an input layer of the original AI model, a top-level partition including an output layer of the original AI model, and a plurality of middle-level partitions including one or more intermediate layers between the input layer and the output layer, the divided original AI model forming an AI model;
generating the augmented tree model of the AI model, the augmented tree model including multiple levels, each level corresponding to one partition of the original AI model, the multiple levels including a top level, a bottom-level, and one or more middle levels, the top level comprising the top-level partition as a root node, the bottom level comprising multiple copies of the bottom-level partition as leaf nodes, each middle level comprising multiple copies of the corresponding middle-level partition as branch nodes, the root node being linked with a plurality of branch nodes of a middle level adjacent to the top level, each branch node being linked to a plurality of leaf nodes or a plurality of branch nodes in the lower level, the root node, the branch nodes, and the leaf nodes forming a plurality of nodes of the augmented tree model; and
instantiating one of the plurality of nodes of the augmented tree model into one of a plurality of entities of a network.

2. The method of claim 1, further comprising receiving computing resources of the plurality of nodes.

3. The method of claim 1, further comprising receiving link information of a plurality of links connecting the plurality of nodes within the network.

4. The method of claim 1, wherein the dividing of the original AI model is based on computing resources of the plurality of nodes and computing load requirements of each of the plurality of partitions.

5. The method of claim 1, wherein the instantiating of the one of the plurality of nodes of the augmented tree model into one of the plurality of entities of the network is based on matching computing resources of the one of the plurality of entities with computing load requirements of the one of the plurality of nodes and on matching link information of a plurality of links connected to the one of the plurality of entities to a communication requirement of the one of the plurality of nodes.

6. The method of claim 1, wherein the plurality of leaf nodes linking to a same branch node have similar available computing resources.

7. The method of claim 1, wherein the plurality of leaf nodes are configured to communicate with each other to transmit parameters of the plurality of leaf nodes, or a plurality of branch nodes in a same level are configured to communicate with each other to transmit parameters of the plurality of branch nodes.

8. The method of claim 1, further comprising, receiving a PSL request including partition requirements of the original AI model and augmented tree model requirements.

9. The method of claim 8, wherein the PSL request further includes model parameters of the original AI model including any of weights and bias of neurons and links, dropout rate associated with layers, and inter-layer dependency information of adjacent layers.

10. The method claim 1, further comprising one or more of:
receiving, by a branch node of the one or multiple middle levels or the root node, forward propagation (FP) data from a linked branch node of an adjacent lower middle level or a linked leaf node of an adjacent lower bottom level;
receiving, by a branch node of the one or multiple middle level, backward propagation (BP) data from a linked branch node of an adjacent higher middle level or a linked root node of an adjacent higher top level;
receiving, by a leaf node, backward propagation (BP) data from a linked branch node of an adjacent higher middle level; or
synchronizing, by a node, parameters of the node to the nodes at the same level as the node, the node is one of the root node, branch node or leaf node.

11. A method for dynamically performing a dropout neuron or link update when training a distributed artificial intelligence (AI) model, the method being performed by a dynamic dropout controller, the method comprising:
receiving a dynamic dropout control (DRC) request including information of a target node, the target node being one of a plurality of nodes in a partition of the distributed AI model, wherein the distributed AI model is split into a plurality of partitions, and at least two adjacent partitions of the plurality of partitions are deployed on different network entities interconnected by network links;
sending, to a network entity deploying the target node, a request for outage probability information of links connecting the target node to the adjacent partition of the target node;
receiving, from the network entity deploying the target node, the outage probability information;
calculating, based on the outage probability information, a dropout rate indicator for the target node, the dropout rate indicator being used to determine an average dropout rate to be applied by the neurons on an input layer of the target node; and
sending, to the network entity deploying the target node, the dropout rate indicator, the dropout rate indicator configuring the target node to execute dynamic dropout when training the distributed AI model.

12. The method of claim 11, wherein the average dropout rate includes a set of available values.

13. The method of claim 11, wherein the dropout rate indicator is associated with the link connecting the target node to the adjacent partition in the distributed AI model.

14. The method of claim 11, wherein the dropout rate indicator is calculated to meet a dropout requirement of the distributed AI model.

15. The method of claim 11, wherein the distributed AI model includes an augmented tree model.

16. The method of claim 15, wherein the outage probability information includes the outage probability information of links connecting the target node to a child node of the target node in the augmented tree model.

17. The method of claim 15, wherein the dropout rate indicator is associated with one of the links connecting the target node to a child node of the target node in the augmented tree model.

18. An apparatus for generating and instantiating an augmented tree model from an original artificial intelligence (AI) model, the apparatus comprising:
a parallel and split learning (PSL) controller including at least one processor and at least one tangible, non-transitory computer readable memory, wherein the at least one tangible, non-transitory computer readable memory stores program instructions, when executed by the at least one processor, cause the apparatus to perform operations comprising:
dividing the original AI model into a plurality of partitions, the plurality of partitions including a bottom-level partition including an input layer of the original AI model, a top-level partition including an output layer of the original AI model, and a plurality of middle-level partitions including one or more intermediate layers between the input layer and the output layer, the divided original AI model forming an AI model;
generating the augmented tree model of the AI model, the augmented tree model including multiple levels, each level corresponding to one partition of the original AI model, the multiple levels including a top level, a bottom-level, and one or more middle levels, the top level comprising the top-level partition as a root node, the bottom level comprising multiple copies of the bottom-level partition as leaf nodes, each middle level comprising multiple copies of the corresponding middle-level partition as branch nodes, the root node being linked with a plurality of branch nodes of a middle level adjacent to the top level, each branch node being linked to a plurality of leaf nodes or a plurality of branch nodes in the lower level, the root node, the branch nodes, and the leaf nodes forming a plurality of nodes of the augmented tree model; and
instantiating one of the plurality of nodes of the augmented tree model into one of a plurality of entities of a network.

19. The apparatus of claim 18, wherein the operations further comprise receiving computing resources of the plurality of nodes.

20. The apparatus of claim 18, wherein the operations further comprise receiving link information of a plurality of links connecting the plurality of nodes within the network.
